(19) United States
(12) Patent Application Publication
(10) Pub. No.: US 2016/0104587 A1
(43) Pub. Date: Apr. 14, 2016

(54) PUSH SWITCH

(71) Applicants: CITIZEN ELECTRONICS CO., LTD., Yamanashi (JP); CITIZEN HOLDINGS CO., LTD., Tokyo (JP)

(72) Inventors: Tetsu OYAMADA, Yamanashi (JP); Tsuyoshi MIURA, Yamanashi (JP); Mitsunori MIURA, Yamanashi (JP)

(21) Appl. No.: 14/877,739

(22) Filed: Oct. 7, 2015

(30) Foreign Application Priority Data
Oct. 9, 2014 (JP) 2014-208347

(51) Int. Cl. H01H 13/14; H01H 13/50

(52) U.S. Cl. CPC H01H 13/14; H01H 13/50; H01H 2205/016; H01H 2215/004

(57) ABSTRACT

Provided is a push switch which has less variations in load characteristic and operation life among products and the deformation of a press member is kept small. The push switch includes a case including a recess, first and second fixed contact points arranged on a bottom surface defining the recess, a bulging dome-shaped movable member placed on the bottom surface so that an end portion thereof is in contact with the first fixed contact point, the movable member electrically connecting the first and second fixed contact points when the dome configuration is inverted by pressing, a protective sheet covering the recess, and a press member clamped between the protective sheet and the movable member, pressing the movable member and including a top surface which is in contact with the protective sheet, and a flat bottom surface which is smaller than the top surface and is in contact with the movable member.

### CROSS REFERENCE TO RELATED APPLICATION

This application is a new U.S. patent application that claims benefit of JP 2014-208347, filed on Oct. 9, 2014. The entire contents of JP 2014-208347 are hereby incorporated by reference.

### TECHNICAL FIELD

The present invention relates to a push switch.

### BACKGROUND

Push switches are known as button switches used for electronic devices such as a cellular phone and an audio device. With the recent miniaturization of switches on the order of about several millimeters, a push switch including a press member (projecting portion) in its operation portion is widely employed to improve the operability. Japanese Laid-open Patent Publication No. 2011-100549, for example, discloses a push switch including a board, a central contact point, a pair of peripheral contact points, a dome-shaped movable contact spring, a flexible support sheet, an upper projecting portion, and a lower projecting portion. The board includes an accommodation recess in its upper surface. The central contact point and the pair of peripheral contact points are located in the accommodation recess. The movable contact spring is extended across the pair of peripheral contact points and comes into contact with the lower, central contact point upon elastic inversion by pressing. The support sheet closes the opening of the accommodation recess. The upper projecting portion is formed on the upper surface of the support sheet and directly above the head of the movable contact spring. The lower projecting portion is formed on the lower surface of the support sheet and directly above the head of the movable contact spring.

However, when a press member is placed on the upper side of a protective sheet (support sheet) which seals a movable member (movable contact point), the press member readily peels due to an external force. One switch is known to include a press member placed only on the lower side of the protective sheet. Japanese Laid-open Patent Publication No. 2008-097913, for example, discloses a switch including a circuit board, a dome-shaped movable contact point, a support sheet, a press operation panel, and a presser. The circuit board is formed by placing a contact electrode on part of the surface of an insulating substrate. The movable contact point is opposed to the contact electrode and capable of inverse deformation. The support sheet is placed on the dome outer surface of the movable contact point and supports the movable contact point to be inversely deformable. The press operation panel is placed on the support sheet. The presser overlaps the contact electrode on the side of the support sheet of the press operation panel and the dome top of the movable contact point.

In general, the click rate is used as an index indicating the touching comfort of a push switch upon its press operation. The click rate is the ratio between the local maximum value of the operation load when the curve of a dome-shaped movable member of the push switch starts to be inverted by applying an operation load to the movable member and the amount of reduction in operation load before the curve of the movable member is completely inverted by further applying an operation load to the movable member. The higher the click rate, the more preferable the obtained sense of touch (sense of click) for the operator upon his or her press operation. However, even in the same push switch, the more the position applied with the operation load is shifted from the center of the operation portion, the lower the click rate and the poorer the sense of press.

### SUMMARY

In a small push switch including an operation portion with a width of, for example, about 1 mm, when the position applied with the operation load by the press member is shifted, albeit slightly, from the center of the movable member, the click rate steeply lowers, thus causing variations in load characteristic (click rate) of individual push switches. Further, pressing the portion shifted from the center of the movable member forcibly deforms the dome configuration of the movable member, thus shortening the operation life of the movable member. To solve these problems, the press member preferably has as thin a lower portion as possible, instead of cylindrical upper and lower surfaces having the same diameter, to apply an operation load as close to the center of the movable member as possible. However, since a resin press member is widely employed, forming too thin a lower portion in the press member concentrates the operation load on one point and this may disadvantageously deform the press member.

In view of this, it is an exemplary object of the present invention to provide a push switch which has less variations in load characteristic and operation life among products and keeps small the deformation of a press member which presses a movable member.

Provided is a push switch including a case including a recess, a first fixed contact point and a second fixed contact point arranged on a bottom surface defining the recess, a movable member including a bulging dome configuration, the movable member being placed on the bottom surface so that an end portion of the movable member is in contact with the first fixed contact point, the movable member electrically connecting the first fixed contact point and the second fixed contact point to each other when the dome configuration is inverted by pressing, a protective sheet which covers the recess, and, a press member clamped between the protective sheet and the movable member, the press member including a top surface which is in contact with the protective sheet, and a flat bottom surface which has a smaller area than the top surface and is in contact with the movable member, the press member being configured to press the movable member.

The press member preferably includes a basal portion including a top surface which is in contact with the protective sheet, and a projecting portion including a bottom surface which is in contact with the movable member, the projecting portion projecting from the basal portion at a center of the basal portion, the projecting portion being curved to bulge toward the movable member.

The press member preferably includes a basal portion including a top surface which is in contact with the protective sheet, and a flat plate-shaped projecting portion including a bottom surface which is in contact with the movable member, the projecting portion projecting from the basal portion at a center of the basal portion.

The press member preferably includes a trapezoidal vertical cross-section with an upper base which is in contact with the protective sheet, and a lower base which is in contact with the movable member and is shorter than the upper base.

The press member is preferably curved so that a lower portion of the press member including the bottom surface that is in contact with the movable member bulges toward the movable member.

The ratio of the area of the bottom surface of the press member to that of the top surface of the movable member is preferably between 1% and 7% both inclusive.

The above push switch has less variations in load characteristic and operation life among products and keeps small the deformation of a press member which presses a movable member.

### BRIEF DESCRIPTION OF THE DRAWINGS

Other features and advantages of the present invention will be apparent from the ensuing description, taken in conjunction with the accompanying drawings, in which:

FIGS. 1 to 5A are a perspective view, an exploded perspective view, a top view, a bottom view, and a sectional view taken along a line VA-VA in FIG. 1, respectively, of a push switch 1;

FIG. 5B is an enlarged view illustrating a cross-section of the press member 40 illustrated in FIG. 5A;

FIG. 5C is an enlarged view illustrating a cross-section of another press member 40′;

FIG. 6A is a sectional view illustrating a push switch 2, as in FIG. 5A;

FIG. 6B is an enlarged view illustrating a cross-section of the press member 50 illustrated in FIG. 6A;

FIG. 6C is an enlarged view illustrating a cross-section of another press member 50′;

FIG. 7 is a sectional view illustrating a push switch 3, as in FIG. 5A;

FIG. 8 is a sectional view illustrating a push switch 4, as in FIG. 5A;

FIGS. 9A to 9E are views for explaining experimental results each obtained by measuring a change in click rate at the position applied with the operation load; and

FIGS. 10A and 10B are views illustrating experimental results each obtained by measuring a change in click rate that depends on the area of the bottom surface of the press member.

### DESCRIPTION

Hereinafter, with reference to the drawings, push switches will be described. It should be noted that the technical scope of the present invention is not limited to embodiments of the invention, but covers the invention described in the claims and its equivalent.

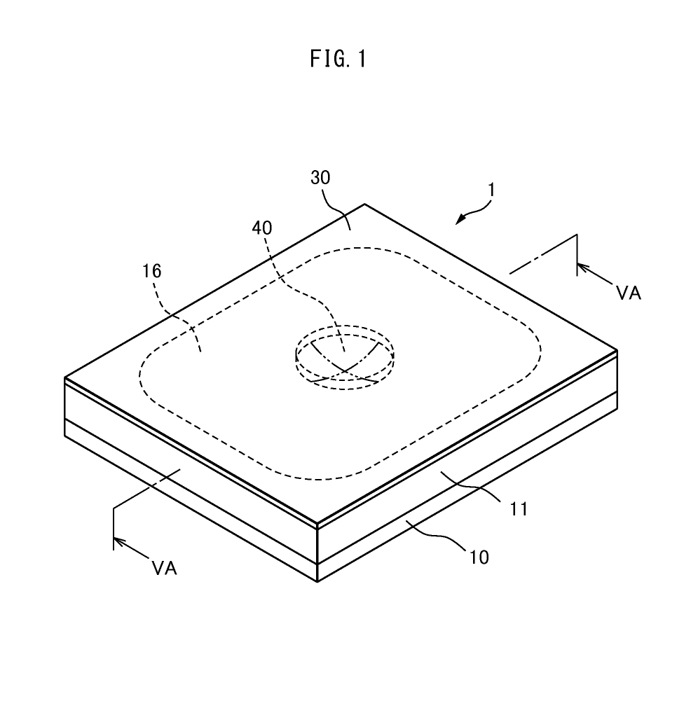

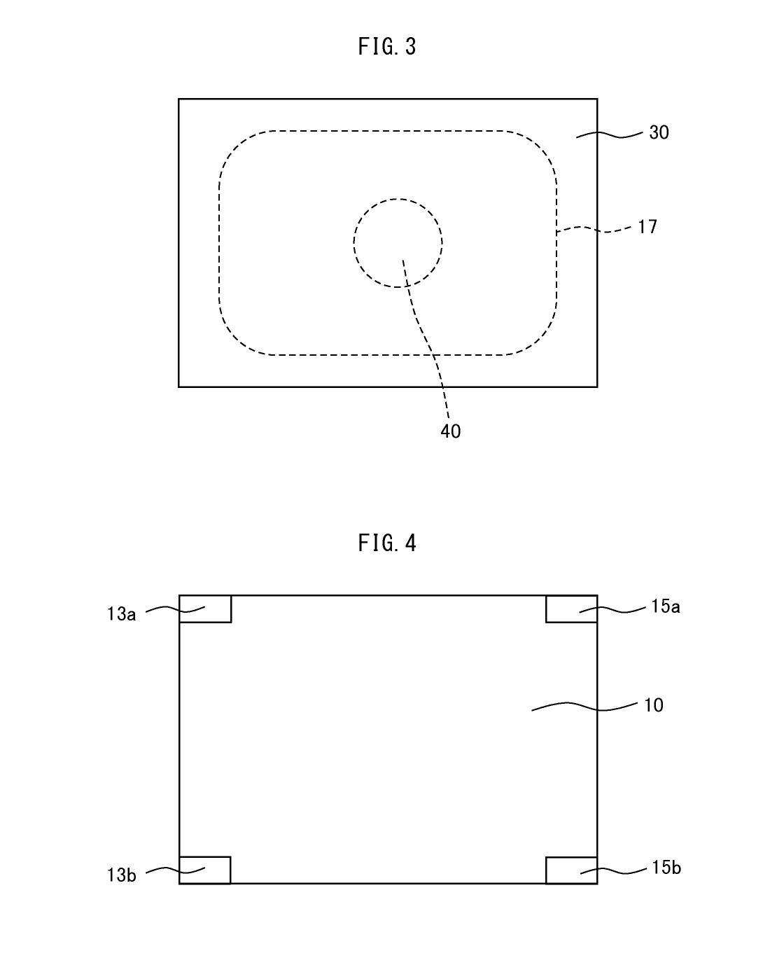

FIGS. 1 to 5A are a perspective view, an exploded perspective view, a top view, a bottom view, and a sectional view taken along a line VA-VA in FIG. 1, respectively, of a push switch 1. The push switch 1 includes a board 10, a fixed sheet 11, a tactile spring 20, a protective sheet 30, and a press member 40 as its main components. The push switch 1 is a tactile switch including a projecting portion formed in its operation portion by the press member 40, and has, for example, planar dimensions of 3 mm×2 mm and a height of 1 mm.

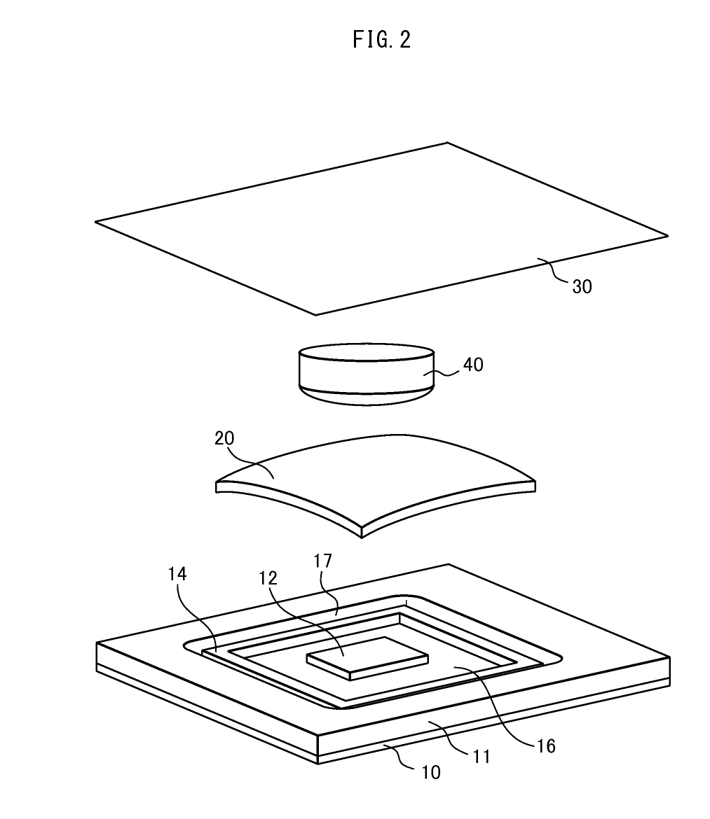

A central contact point 12 and an external contact point 14 are formed on the upper surface of the board 10, as depicted in FIG. 2. The fixed sheet 11 is a rectangular frame-shaped member formed of a resin to fit the board 10 and is bonded to the upper surface of the board 10 through an adhesive sheet (not illustrated). However, the board 10 and the fixed sheet 11 may be integrally formed using an insert mold, instead of bonding the board 10 and the fixed sheet 11 to each other. The board 10 and the fixed sheet 11 serve as a case for the push switch 1 and form a recess 16 to accommodate the tactile spring 20 inside.

The external contact point 14 and the central contact point 12 exemplify first and second fixed contact points arranged on a bottom surface defining the recess 16. The central contact point 12 is a conductor having a quadrate flat surface and is located at the central portion of the surface of the board 10. The external contact point 14 is a conductor having a frame-shaped flat surface and is located on the surface of the board 10 along an inner wall 17 of the fixed sheet 11 to surround the central contact point 12.

Electrodes 13a, 13b, 15a, and 15b for connecting the push switch 1 to an external device are formed on the lower surface of the board 10, as illustrated in FIG. 4. The electrodes 13a and 13b are electrically connected to the central contact point 12 via a through-hole electrode and back wiring (neither is illustrated). The electrodes 15a and 15b are electrically connected to the external contact point 14 via a through-hole electrode and back wiring (neither is illustrated). An insulating sheet material made of an insulating synthetic resin is placed on the lower surface of the board 10.

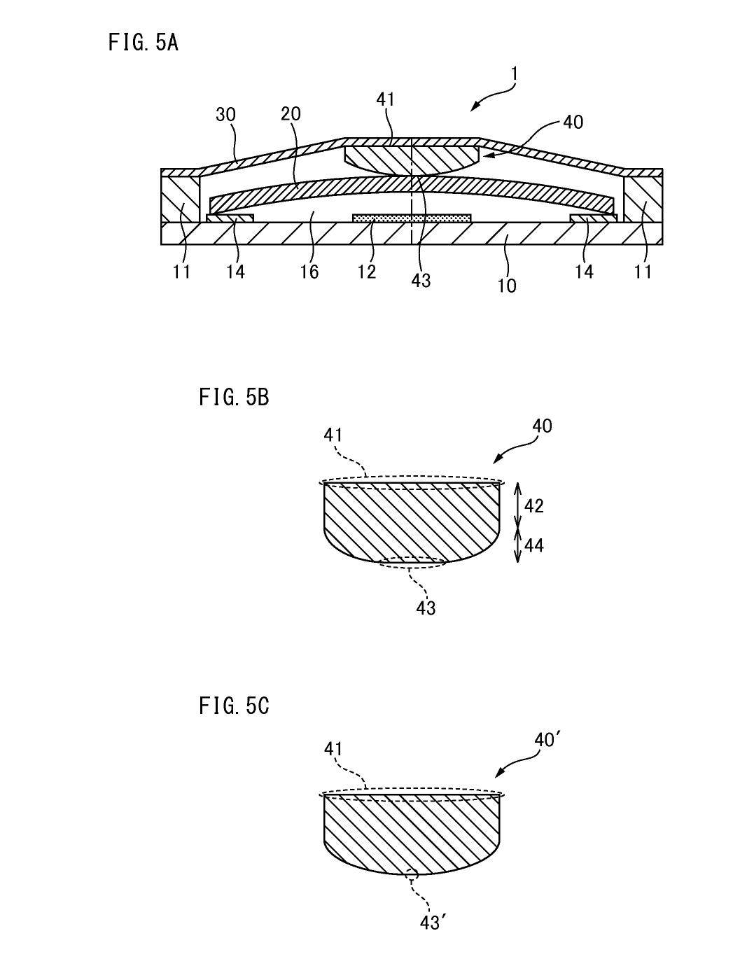

The tactile spring 20 exemplifies a movable member and is made of, for example, stainless steel. As depicted in FIGS. 2 and 5A, the tactile spring 20 has a bulging dome configuration and is placed on a bottom surface defining the recess 16 (i.e., on the board 10) so that its end portions are in contact with the external contact point 14. Upon being applied with an operation load and pressed, the tactile spring 20 deforms so that its dome configuration has a crushed curve and is at least partially inverted and brought into contact with the central contact point 12. This electrically connects the central contact point 12 and the external contact point 14 to each other to turn on the switch. The tactile spring 20 is restored to its original dome shape after the removal of the operation load. This electrically disconnects the central contact point 12 and the external contact point 14 from each other to turn off the switch. The tactile spring 20 may deform in a dent only at its central portion or deform in a dent as a whole.

The protective sheet 30 is a flexible insulating resin sheet and the end portions of its lower surface are bonded to the upper surface of the fixed sheet 11 to cover the recess 16. The protective sheet 30 seals (hermetically seals) the tactile spring 20 and the press member 40 in the recess 16, together with the board 10 and the fixed sheet 11.

The press member 40 is a resin member (actuator) for pressing the tactile spring 20 and is interposed between the tactile spring 20 and the protective sheet 30, thereby being fixed in position (clamped) by these members, as depicted in FIG. 5A. The press member 40 functions to transmit to the tactile spring 20, a push force (operation load) acting upon pressing of a presser (not illustrated).

FIG. 5B is an enlarged view illustrating a cross-section of the press member 40 illustrated in FIG. 5A. As illustrated as FIG. 5B, the press member 40 includes an upper portion 42 and a curved lower portion 44. The upper portion 42 includes a top surface 41 which is in contact with the protective sheet 30. The lower portion 44 includes a flat bottom surface 43 which is in contact with the tactile spring 20. The upper portion 42 has a disk shape while the lower portion 44 has a shape close to part of a sphere and is curved to bulge toward the tactile spring 20. In the press member 40, the bottom surface 43 has a width smaller than that of the top surface 41 and therefore the bottom surface 43 has an area smaller than that of the top surface 41. For example, the top surface 41 forms a 0.6-mm diameter circle, the bottom surface 43 forms a 0.2-mm diameter circle, and the height of the press member 40 that is the total height of the upper portion 42 and the lower portion 44 is 0.2 mm. The press member 40 is fabricated as, for example, a resin molded product.

As described above, in the push switch 1, the top surface 41 of the press member 40 corresponding to the operation portion has as large an area as possible, and the bottom surface 43 of the press member 40 that is in contact with the tactile spring 20 has as small an area as possible. Making the top surface 41 have a large area facilitates mounting of the press member 40 in the manufacture and ensures sufficient operability of the push switch 1. On the other hand, making the bottom surface 43 have a small area allows concentration of the operation load on a narrow range in the vicinity of the center of the tactile spring 20, thus reducing variations in load characteristic (click rate) among products. In addition, concentrating the operation load on the vicinity of the center of the tactile spring 20 reduces stress placed on the tactile spring 20, so that the operation life of the tactile spring 20 improves and variations in operation life among products reduce. Further, since the press member 40 is in contact with the tactile spring 20 not at one point but in a plane of the lower portion 44, the press member 40 ensures sufficient strength and is less prone to deformation by the operation load.

A push switch 1 which uses a press member 40 including a top surface 41 forming a 0.6-mm diameter circle and a bottom surface 43 forming a 0.2-mm diameter circle, and a push switch which uses a cylindrical press member including top and bottom surfaces each forming a 0.6-mm diameter circle were set and an examination for comparing their click rates and operation lives was conducted. First, when an operation load was applied from the upper side of the protective sheet 30 to a horizontal position of 0.3 mm from the center of the tactile spring 20, the click rate was 78% for the push switch including the cylindrical press member and increased to 88% using the push switch 1. The tactile spring 20 was damaged after about 300,000 operations for the push switch including the cylindrical press member, while the tactile spring 20 suffered no damage even after 640,000 operations for the push switch 1; the operation life improved to twice or more using the push switch 1. It was, therefore, confirmed that making the area of the bottom surface 43 smaller than that of the top surface 41 of the operation member improves the click rate and the operation life.

FIG. 5C is an enlarged view illustrating a cross-section of another press member 40′. Although the press member 40 illustrated as FIG. 5B includes a flat bottom surface 43 which is in contact with the tactile spring 20, the entire lower portion of the press member may have a spherical shape, as in the press member 40′ illustrated as FIG. 5C, as long as a resin forming the press member can ensure sufficient strength. In this case, a bottom surface 43′ which is in contact with the tactile spring 20 forms merely part of the lower end of the sphere.

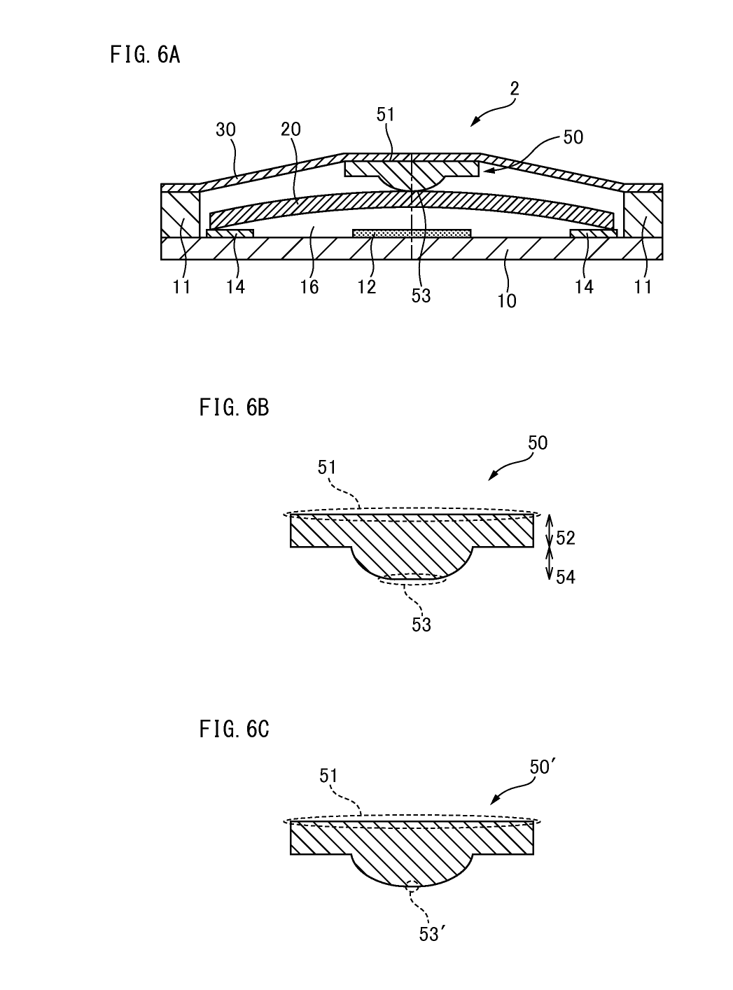

FIG. 6A is a sectional view illustrating a push switch 2, as in FIG. 5A. The push switch 2 illustrated as FIG. 6A includes a press member 50 in place of the press member 40 and is different from the push switch 1 depicted as FIGS. 1 to 5B in terms of only the shape of the press member. The same reference numerals denote the same components as in the push switch 1, and a description thereof will not be repeated.

FIG. 6B is an enlarged view illustrating a cross-section of the press member 50 illustrated in FIG. 6A. As illustrated as FIG. 6B, the press member 50 includes a basal portion 52 and a projecting portion 54. The basal portion 52 includes a top surface 51 which is in contact with a protective sheet 30. The projecting portion 54 includes a flat bottom surface 53 which is in contact with a tactile spring 20, and projects from the basal portion 52 at the center of the basal portion 52. The basal portion 52 has a disk shape, like the upper portion 42 of the press member 40, while the projecting portion 54 is smaller than the lower portion 44 of the press member 40, has a shape close to part of a sphere, and is curved to bulge toward the tactile spring 20. In the press member 50, unlike the press member 40, a step is formed between the basal portion 52 and the projecting portion 54. Therefore, in the press member 50, the bottom surface 53 has an area smaller than that of the top surface 51. For example, the top surface 51 forms a 0.6-mm diameter circle, the bottom surface 53 forms a 0.2-mm diameter circle, and the height of the press member 50 that is the total height of the basal portion 52 and the projecting portion 54 is 0.2 mm. The press member 50 is fabricated by, for example, bonding the projecting portion 54 to a press member of an existing push switch corresponding to the basal portion 52, using the resin printing or potting method.

In the push switch 2 as well, since the bottom surface 53 of the press member 50 that is in contact with the tactile spring 20 has an area smaller than that of the top surface 51, variations in load characteristic and operation life among products are kept small, as in the push switch 1. Further, since the press member 50 is in contact with the tactile spring 20 not at one point but in a plane of the projecting portion 54, the press member 50 ensures sufficient strength and is less prone to deformation by the operation load.

FIG. 6C is an enlarged view illustrating a cross-section of another press member 50′. Although the press member 50 illustrated as FIG. 6B includes a flat bottom surface 53 which is in contact with the tactile spring 20, the entire projecting portion of the press member may have a spherical shape, as in the press member 50′ illustrated as FIG. 6C, as long as a resin forming the press member can ensure sufficient strength. In this case, a bottom surface 53′ which is in contact with the tactile spring 20 forms merely part of the lower end of the sphere.

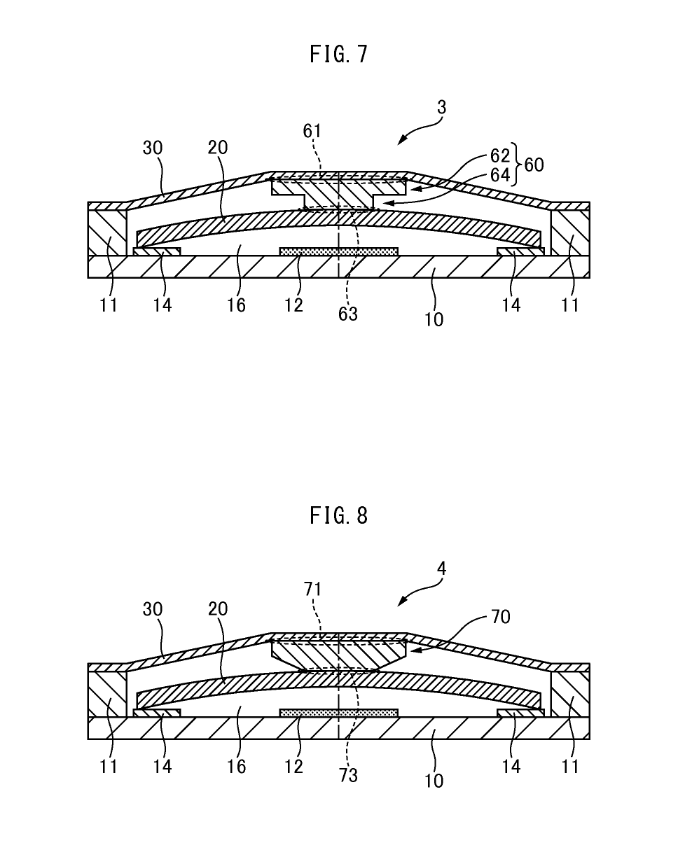

FIG. 7 is a sectional view illustrating a push switch 3, as in FIG. 5A. The push switch 3 illustrated as FIG. 7 includes a press member 60 in place of the press member 40 and is different from the push switch 1 depicted as FIGS. 1 to 5B in terms of only the shape of the press member. The same reference numerals denote the same components as in the push switch 1, and a description thereof will not be repeated.

As illustrated in FIG. 7, the press member 60 includes a basal portion 62 and a flat plate-shaped projecting portion 64. The basal portion 62 includes a top surface 61 which is in contact with a protective sheet 30. The projecting portion 64 includes a flat bottom surface 63 which is in contact with a tactile spring 20, and projects from the basal portion 62 at the center of the basal portion 62. In the press member 60, both the basal portion 62 and the projecting portion 64 have a disk (flat plate) shape, and a step is formed between the basal portion 62 and the projecting portion 64 because the projecting portion 64 has a width smaller than that of the basal portion 62. Therefore, in the press member 60, the bottom surface 63 has an area smaller than that of the top surface 61. For example, the top surface 61 forms a 0.6-mm diameter circle, the bottom surface 63 forms a 0.4-mm diameter circle, and the height of the press member 60 that is the total height of the basal portion 62 and the projecting portion 64 is 0.2 mm. The press member 60 is fabricated by, for example, laminating two resin flat plates corresponding to the basal portion 62 and the projecting portion 64, together.

In the push switch 3 as well, since the bottom surface 63 of the press member 60 that is in contact with the tactile spring 20 has an area smaller than that of the top surface 61, variations in load characteristic and operation life among products are kept small, as in the push switch 1. Further, since the press member 60 is in contact with the tactile spring 20 not at one point but in a plane of the projecting portion 64, the press member 60 ensures sufficient strength and is less prone to deformation by the operation load.

FIG. 8 is a sectional view illustrating a push switch 4, as in FIG. 5A. The push switch 4 illustrated as FIG. 8 includes a press member 70 in place of the press member 40 and is different from the push switch 1 depicted as FIGS. 1 to 5B in terms of only the shape of the press member. The same reference numerals denote the same components as in the push switch 1, and a description thereof will not be repeated.

The press member 70 has a trapezoidal vertical cross-section with an upper base (top surface 71) which is in contact with a protective sheet 30, and a lower base (bottom surface 73) which is in contact with a tactile spring 20 and is shorter than the upper base, as illustrated in FIG. 8. In other words, the press member 70 has its cylindrical portion, in the vicinity of the bottom surface, tapered down toward the bottom surface. Therefore, in the press member 70, the bottom surface 73 has an area smaller than that of the top surface 71. For example, the top surface 71 forms a 0.6-mm diameter circle, the bottom surface 73 forms a 0.4-mm diameter circle, and the height of the press member 70 is 0.2 mm. The press member 70 is fabricated as, for example, a resin molded product, like the press member 40.

In the push switch 4 as well, since the flat bottom surface 73 of the press member 70 that is in contact with the tactile spring 20 has an area smaller than that of the top surface 71, variations in load characteristic and operation life among products are kept small, as in the push switch 1. Further, since the press member 70 is in contact with the tactile spring 20 not at one point but in a plane, the press member 70 ensures sufficient strength and is less prone to deformation by the operation load.

Of the press members 40, 50, 60, and 70 of the push switches 1 to 4 mentioned above, the press member 50 is obtained simply by bonding the projecting portion 54 to a press member of an existing push switch, using the resin printing or potting method, and is therefore easiest to fabricate. In addition, since the strength of the press member is higher in the press members 60 and 70 having a relatively large bottom surface area than in the press members 40 and 50, the press members 60 and 70 are less prone to deformation by the operation load than the press members 40 and 50. In contrast, the click rate is higher in the press members 40 and 50 that have a relatively small bottom surface area and therefore have an operation load concentrated on a relatively narrow range than in the press members 60 and 70.

The area ratio between each of the top surfaces 41, 51, 61, and 71 and the corresponding one of the bottom surfaces 43, 53, 63, and 73 for the press members 40, 50, 60, and 70 is 11% in the press members 40 and 50 and 44% in the press members 60 and 70. Therefore, the press member preferably has a bottom surface area of nearly 10% (inclusive) to 45% (inclusive) of the area of the top surface of the press member.

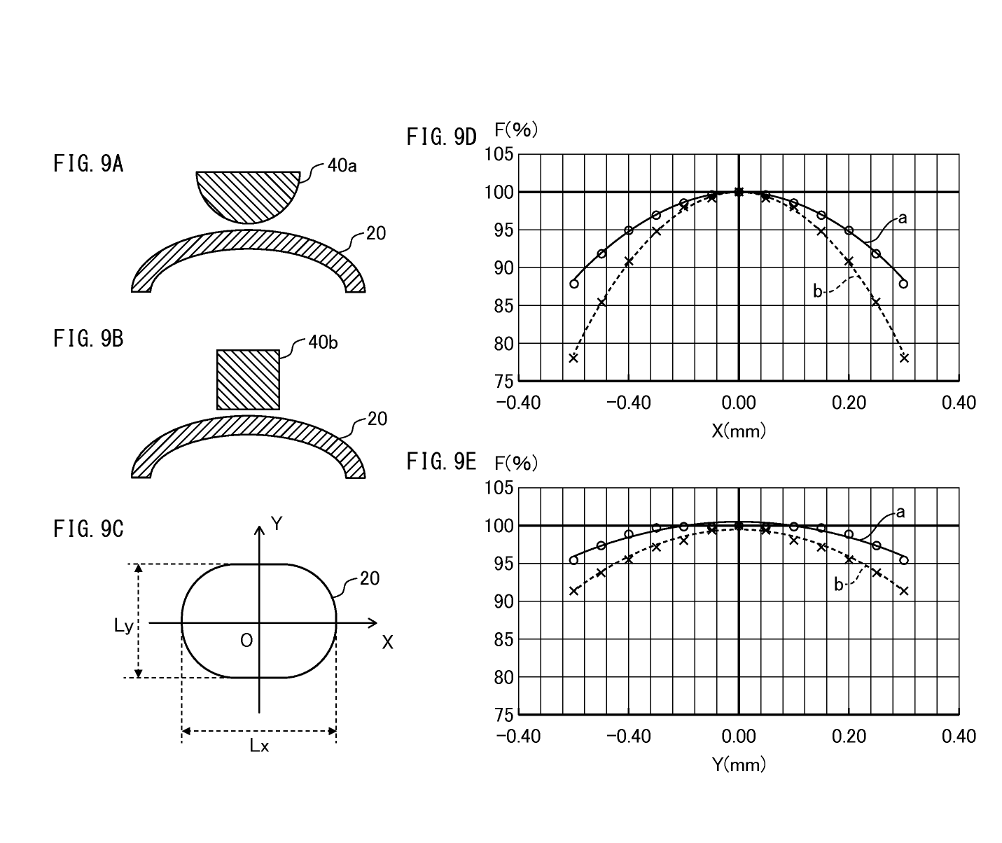

FIGS. 9A to 9E are views for explaining experimental results each obtained by measuring a change in click rate at the position applied with the operation load. In this experiment, the inventors of the present invention measured the click rate when the press member was pressed at varying positions relative to the tactile spring 20, for two push switches having the same configuration as that of the push switch 1, except for the shape of the press member, and compared the measurement results with each other.

FIGS. 9A and 9B are vertical sectional views illustrating the shape of a press member 40a of one push switch (a) used in measurement and that of a press member 40b of the other push switch (b), respectively. The lower end of the press member 40a of push switch (a) forms a curved surface having a curvature equal to that of a 0.8-mm diameter sphere, and presses the tactile spring 20 at one point. The lower end of the press member 40b of push switch (b) forms a 0.45-mm diameter, flat circle and presses the tactile spring 20 in a plane.

FIG. 9C is a top view of the tactile spring 20 used in measurement. The tactile spring 20 has a bulging dome shape, as described above, as viewed sideways but has a shape close to an ellipse, as depicted as FIG. 9C, when viewed from above. Orthogonal X- and Y-directions are defined in a horizontal plane, as illustrated in FIG. 9C. The tactile spring 20 has a diameter of φ2 mm, an X-dimension Lx of 2 mm and a Y-dimension Ly of 1.5 mm.

FIGS. 9D and 9E are graphs each illustrating the relationship between the click rate and the center position applied with the operation load. The abscissa of each of FIGS. 9D and 9E represents the horizontal position with the center of the tactile spring 20 taken as the origin O. The abscissa of FIG. 9D represents the X-position (mm) and the abscissa of FIG. 9E represents the Y-position (mm). The ordinate of each of FIGS. 9D and 9E represents the click rate F (%) as a relative value, assuming the click rate upon application of the operation load to the center of the tactile spring 20 as 100%. Curves a and b of each of FIGS. 9D and 9E represent the above-mentioned results obtained for push switches (a) and (b), respectively.

Because the dimension of the tactile spring 20 in a horizontal plane is different in the X- and Y-directions, the relationship between the position applied with the operation load and the rate of change in click rate is also different in the X- and Y-directions. However, as can be seen from the graphs illustrated as both FIGS. 9D and 9E, the amount of reduction in click rate is smaller in push switch (a) than in push switch (b) even when a position shifted from the center is pressed. In other words, the smaller the area of the bottom surface of the press member, the smaller the extent to which the click rate reduces due to a shift of the pressed position.

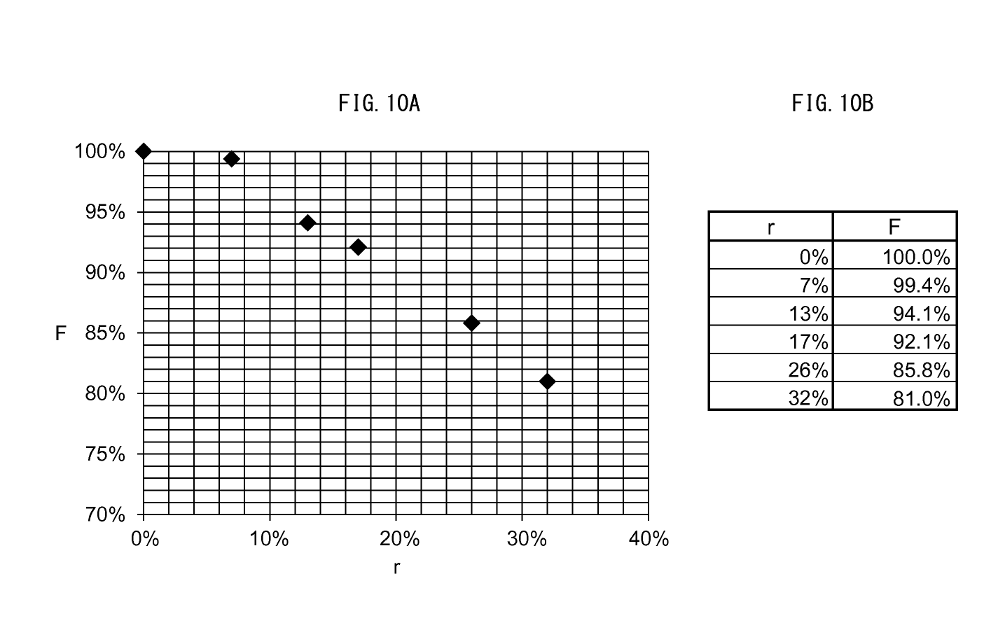

FIGS. 10A and 10B are views illustrating experimental results each obtained by measuring a change in click rate that depends on the area of the bottom surface of the press member. In this experiment, the inventors of the present invention measured the click rate while changing the area of the bottom surface 43 of the press member 40 (the area of contact with the tactile spring 20) in a push switch having the same configuration as that of the push switch 1. The abscissa of FIG. 10A represents the area ratio r (%) of the bottom surface 43 of the press member 40 to the area of a circle having a diameter of 2 mm corresponding to the top surface of the tactile spring 20. The ordinate of FIG. 10A represents the click rate F (%) as a relative value, assuming the click rate upon application of the operation load to the center of the tactile spring 20 as 100%. FIG. 10B is a table providing a numerical representation of the experimental result depicted as FIG. 10A.

As can be seen from the graph illustrated in FIG. 10A, the lower the area ratio r, the smaller the amount of reduction in click rate F, i.e., the higher the area ratio r, the larger the amount of reduction in click rate F. Thus, the smaller the area of pressing of the tactile spring 20, the better the characteristics of the push switch. Considering the experimental results represented as FIGS. 9D and 9E as well, the smaller the area of pressing of the tactile spring 20, the less the change in characteristic of the push switch even when a position shifted from the center of the tactile spring 20 is pressed.

Since the area of the top surface of the tactile spring 20 is about 3.14 mm² and the bottom surface 43 of the press member 40 of the push switch 1 forms a 0.2-mm diameter circle, the area ratio r in the push switch 1 is approximately 1.0%. Considering the strength of the press member 40 against the operation load, the ratio of the area of the bottom surface 43 of the press member 40 to that of the top surface of the tactile spring 20 is preferably 1% or more. Further, the graph illustrated as FIG. 10A reveals that when the area ratio r is 7% or less, the relative value F representing the click rate is 99% or more, which means that the click rate practically remains intact. Hence, in terms of the click rate, the ratio of the area of the bottom surface of the press member to that of the top surface of the tactile spring 20 is preferably 7% or less.

The preceding description has been presented only to illustrate and describe exemplary embodiments of the present invention. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope.

What is claimed is:

1. A push switch comprising:
a case including a recess;
a first fixed contact point and a second fixed contact point arranged on a bottom surface defining the recess;
a movable member including a bulging dome configuration, the movable member being placed on said bottom surface so that an end portion of the movable member is in contact with the first fixed contact point, the movable member electrically connecting the first fixed contact point and the second fixed contact point to each other when the dome configuration is inverted by pressing;
a protective sheet which covers the recess; and
a press member clamped between the protective sheet and the movable member, the press member including a top surface which is in contact with the protective sheet, and a flat bottom surface which has a smaller area than the top surface and is in contact with the movable member, the press member being configured to press the movable member.

2. The push switch according to claim 1, wherein
the press member includes:
a basal portion including a top surface which is in contact with the protective sheet; and
a projecting portion including a bottom surface which is in contact with the movable member, the projecting portion projecting from the basal portion at a center of the basal portion, the projecting portion being curved to bulge toward the movable member.

3. The push switch according to claim 1, wherein
the press member includes:
a basal portion including a top surface which is in contact with the protective sheet; and
a flat plate-shaped projecting portion including a bottom surface which is in contact with the movable member, the projecting portion projecting from the basal portion at a center of the basal portion.

4. The push switch according to claim 1, wherein the press member includes a trapezoidal vertical cross-section with an upper base which is in contact with the protective sheet, and a lower base which is in contact with the movable member and is shorter than the upper base.

5. The push switch according to claim 1, wherein the press member is curved so that a lower portion of the press member including the bottom surface that is in contact with the movable member bulges toward the movable member.

6. The push switch according to claim 1, wherein the ratio of the area of the bottom surface of the press member to that of the top surface of the movable member is between 1% and 7% both inclusive.
